(19) United States
(12) Patent Application Publication
(10) Pub. No.: US 2008/0011839 A1
(43) Pub. Date: Jan. 17, 2008

(54) Material hauling and delivery monitoring system

(76) Inventors: Joseph David Noll, Arlington, TX (US); Nathan Bradley Noll, Arlington, TX (US)

Correspondence Address: GUY V. MANNING, 1407 TEXAS STREET, SUITE 102, FORT WORTH, TX, 76102, US

(21) Appl. No.: 11/243,013

(22) Filed: Oct. 3, 2005

(51) Int. Cl. G07B 15/02; G05D 1/00

(52) U.S. Cl. 235/384; 701/1

(57) ABSTRACT

A system and apparatus monitors dump truck loads and activity. A truck picks up a load and haul ticket at one location, such as a gravel or sand pit, and delivers them to another, such as a job fill site. An operator at the job site scans a bar code on the truck to log arrival of the load and creates a scan record of the arriving or departing truck. A touch screen on the scanner may be used to enter optional numeric data from other sources such as the haul ticket or truck odometer. The operator's hand-held, cellular- or radio-based scanner connects directly to a centralized data processor and uploads scan records through a wireless, internet-based communication link. From such truck and load data, the processor provides contemporaneous reports via internet connection about truck identifications, load sizes and actual delivery times of loads, enabling efficient, automated job management and accounting for invoicing and job site volume of hauling activity, while displacing the laborious handling of manual haul tickets issued at the pickup site and collected by the operator.

### BACKGROUND OF THE INVENTION

1. Field of the Invention

This invention relates generally to systems for tracking vehicles hauling loads, and particularly to such systems adapted to monitor the time, weight, identification number and job associated with a truck hauling a load from one job site to another, and for monitoring progress on the job. More particularly, this invention relates to a scanner that reads bar codes on trucks and conveys information by wireless transmission to a database for tracking truck loads substantially in real time.

2. Description of Related Art

Dump truck hauling services typically pick up a load of material loaded at one location and haul it to another for unloading, such as on a job site where construction is ongoing. Sometimes dump trucks haul debris or excess material from such construction sites to a pre-arranged dump site, to another job site or even to one or more other locations within the same construction area. Manual haul tickets issued at one site and turned in at the other site provide traditional means to account for such loads. Further, pit operators selling weighed fill material from a mine conventionally issue a similar ticket (sometimes called a pit ticket) to the exiting driver who gives it to an operator at the target construction site. Such tickets serve as purchase orders for paying the pit companies and drivers and as an accounting system for construction supervisors to monitor the quantity of materials deposited on their job sites.

Manual ticket systems are cumbersome, however, because of the volume of tickets, the possibility of losing some, and the laborious chore of accumulating and totaling them for accounting purposes. Further, manual systems are vulnerable to fraud when unscrupulous drivers and/or operators issue and turn in duplicate tickets or divert loads to unauthorized sites to purloin the material or to shorten their return trip. A need exists for an automated system of tracking trucks and their loads which reduces fraud and relieves the work load of accounting for invoicing and job progress.

### SUMMARY OF THE INVENTION

Accordingly, it is an object of this invention to provide means of accounting for individual trucks hauling loads from one location to another.

It is another object of this invention to provide means for keeping track of trucks to verify that loads they haul are delivered as intended

It is another object of this invention to provide efficient and economical means for prompt, accurate monitoring of trucked material for construction or debris removal jobs.

It is another object of this invention to provide economical means for accounting for truck hauling loads.

It is yet another object of this invention to provide practical means for reducing fraud and error in tracking volumes of truck loads of material delivered to specific locations.

The foregoing and other objects of this invention are achieved by providing a system and apparatus for monitoring dump truck loads and activity. A truck picks up a load and haul ticket at one location, such as a gravel or sand pit, and delivers them to another, such as a job fill site. An operator at the job site scans a bar code on the truck to log arrival of the load and creates a scan record of the arriving or departing truck. A touch screen on the scanner may be used to enter optional numeric data from other sources such as the haul ticket or truck odometer. The operator's hand-held, cellular- or radio-based scanner connects directly to a centralized data processor and uploads scan records through a wireless, internet-based communication link. From such truck and load data, the processor provides contemporaneous reports via internet connection about truck identifications, load sizes and actual delivery times of loads, enabling efficient, automated job management and accounting for invoicing and job site volume of hauling activity, while displacing the laborious handling of manual haul tickets issued at the pickup site and collected by the operator.

### BRIEF DESCRIPTION OF THE DRAWINGS

The novel features believed characteristic of the present invention may be set forth in appended claims. The invention itself, however, as well as a preferred mode of use and further objects and advantages thereof, will best be understood by reference to the following detailed description of an illustrative embodiment when read in conjunction with the accompanying drawings, wherein:

FIG. 1 depicts for the present invention a schematic of a load hauling routine, truck and load data acquisition and base station interconnection and report generation.

FIG. 2 details a hand-held scanner and optional printer in use.

FIG. 3 depicts a general scheme for accessing the server of FIG. 4.

FIG. 4 depicts the central computer server operating software for the present invention.

FIGS. 5A-5D depict in a flow diagram of the operation of the scanner of FIG. 2.

### DETAILED DESCRIPTION OF A PREFERRED EMBODIMENT

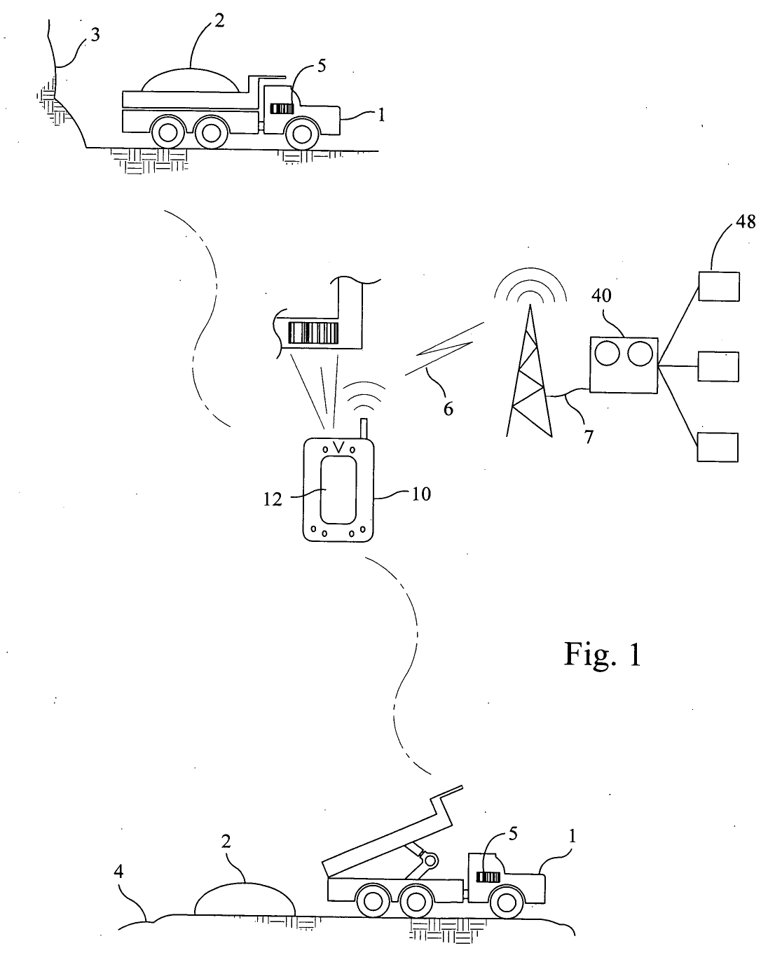

In reference to FIG. 1, a schematic of a typical truck material hauling process is depicted. A procession of trucks 1 picks up loads 2 at a first location, such as a gravel or sand pit (hereinafter “pit”) 3 and delivers them to another location (hereinafter “job site”) 4. NOTE: the present invention is discussed below in the context of trucks 1 obtaining loads 2 from independent mines or pits 3 selling weighed fill material, but one having ordinary skill in the art will recognize that the invention works just as well where trucks 1 haul loads from one location to another within job site 4, or where trucks 1 pick up debris or excess material from job site 4 for disposal elsewhere. Trucks 1 may be owned by operators of pit 3, job site 4 or independent companies or drivers who engage to deliver loads 2 to job site 4. Typically, pit 3 issues haul tickets 25 to the drivers (not shown) of trucks 1 who deliver them along with loads 2 to an operator (not shown) at job site 4. Haul tickets 25 may be accumulated by a contractor (not shown) at job site 4 for ongoing monitoring of construction progress and for later payment for loads 2.

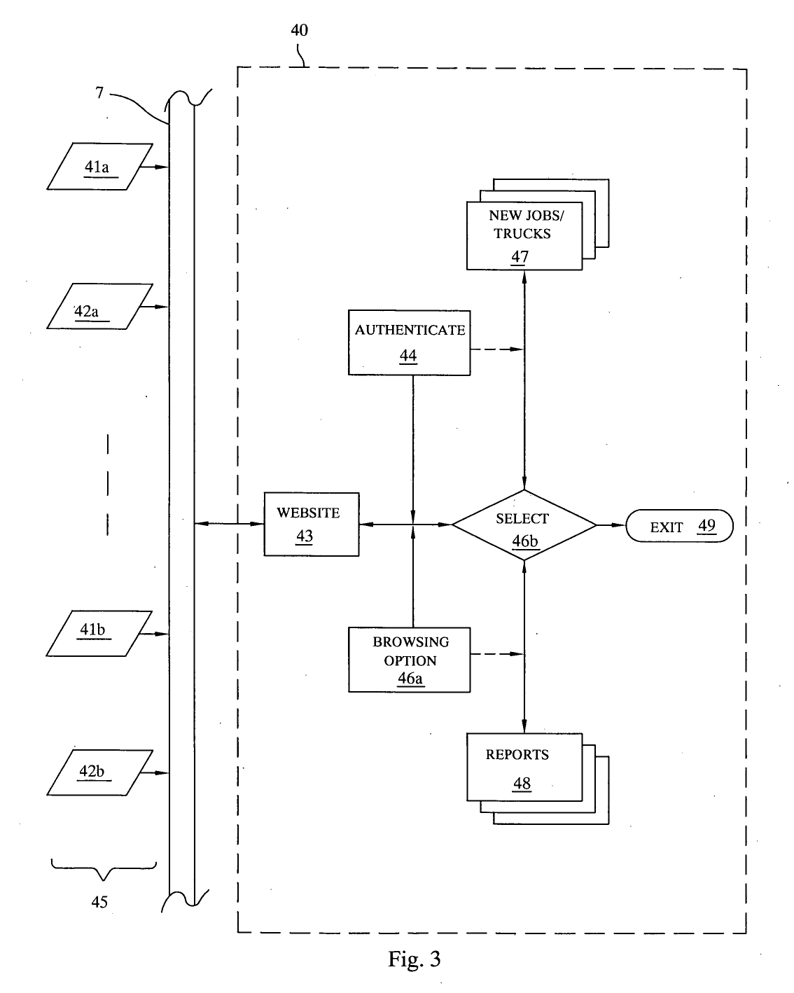

Also depicted in FIG. 1, scanner 10 issued to job site 4 and/or pit 3 operators is adapted to read bar code 5 on each truck 1 for easy and convenient monitoring of pickups and/or deliveries of loads 2. Scanners 10 are cellular- or radio-based devices capable of connecting to internet-based central processor 40 at a remote location. Bar codes 5 are attached to trucks 1 by the operator of scanner 10 and data about each truck 1 is forwarded to processor 40 for processing. A touch keypad (not shown) generated on screen 12 of scanner 10 allows entry of additional data from another source such as haul tickets 25. FIG. 3, discussed in more detail below, shows a generalized scheme of operators 41 and other users 42 accessing processor 40 through, preferably through wireless communication system 6 and/or land-based (commonly telephone) network 7.

FIG. 1 depicts a single scanner 10 positioned between pit 3 and job site 4 but ambiguously so as to which site with which it is associated. It could be either or both. Pit 3 could utilize the present invention to manage its inventory, track trucks 1 purchasing material, and for accurate invoicing. Likewise, a contractor or owner at job site 4 could utilize the present invention to replace the laborious haul ticket 25 method of management of job site 4 and payment for loads 2. Finally, both companies could use the present invention independently, but relying on the same bar codes 5 and concomitant truck 1 data, giving them the capability of contrasting data and resolving conflicts between accountings. Hereinafter, the present invention will be discussed in the context of a contractor managing job site 4, but one having ordinary skill in the art will recognize that all such variations are considered to be within the spirit and scope of the present invention.

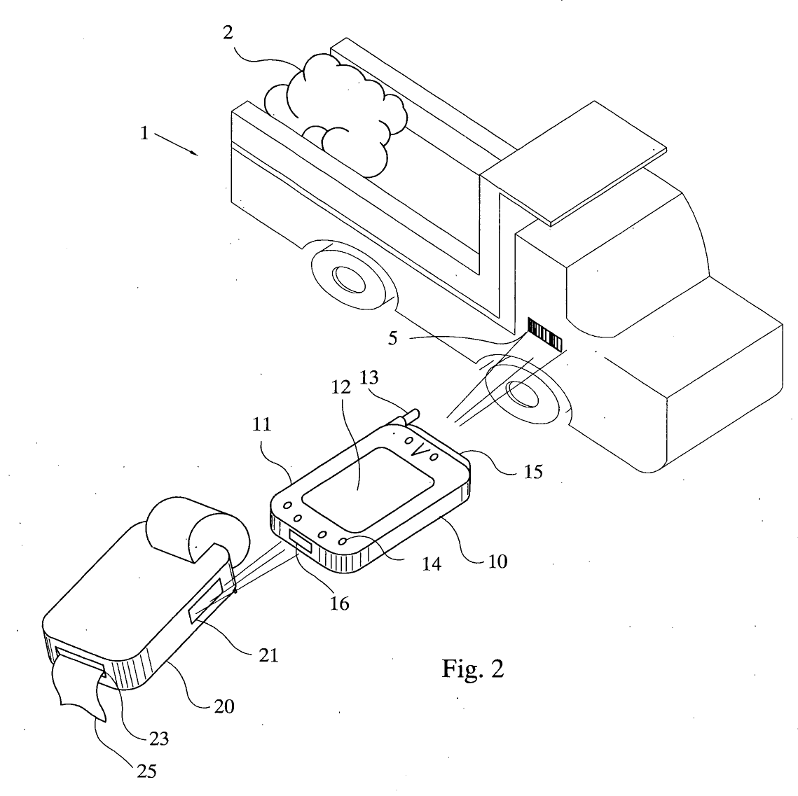

Turning now also to FIG. 2, scanner 10 both scans bar code 5 on truck 1 and interfaces with printer 20 to print haul ticket 25. Scanner 10 is provided to operator 41 (see FIG. 3) on job site 4 responsible for logging each truck 1 as it arrives and for directing it to the location within job site 4 where load 2 should be delivered. Under traditional manual ticket systems, operator 41 validates, signs or accepts haul tickets 25 issued to the drivers of trucks 1 at pit 3 and accumulates them for payment and site 4 management. Though the present invention renders haul tickets 25 obsolete, dramatically reducing the labor of accumulating them and creating in real time an accurate assessment of the amount of material in loads 2 delivered for contrast with engineering requirement, it also can couple to printer 20 to provide print haul tickets 25 as a back-up system in case of loss of data or for receipts for the driver upon delivery of load 2. Haul tickets 25 for arriving loads 2 at job site 4 also may include additional truck and load data, such as the actual weight of load 2 arriving from commercial pit 3, in which case touch screen 12 may be used to enter any such data on haul ticket 25 that the job has been set up to collect.

Scanner 10 comprises a hand-held device having screen 12 programmable as a user interface and equipped with various buttons and a stylus for operating its software to provide the various scanner 10 functions. Those functions include selection of a job with which each truck 1 and load 2 is associated, a scan function for scanning bar codes 5, a print function for printing one or more haul tickets 25 or receipts, and an upload function for passing accumulated truck 1 and load 2 data to processor 40. Scanner 10 is equipped with antenna 13 and associated radio frequency circuitry (not shown) for communicating with wireless system 6. Scanner 10 also includes infrared or other localized wireless scan port 15 for reading bar code 5, and printer transmitter port 16 for interfacing with printer 20.

Printer 20 may be a small, hand-held, portable device kept near the gate (not shown) where trucks 1 arrive, a larger stationary printer and interface (not shown) in a nearby guard shack (not shown), or it may even be integral (not shown) with scanner 10. In any case, printer 20 includes receiver port 21 adapted to interface with transmitter 16 and receive print signals from scanner 10. Printer 20 thus is capable immediately after scanning of producing one or more haul tickets 25 bearing truck 1 identifying information from the software in scanner 10 and on processor 40.

A suitable scanner 10 is available as product number PPT 2837 from Symbol Technologies, Inc. of Holtsville, N.Y. A suitable printer 20 is available as product number MF 4t from O'Neil Product Development Company of Irvine, Calif. Both typically use Windows based operating systems with proprietary software such as that used by the present invention.

Referring again to FIG. 3, computer based network 7 interconnects operators 41 and other users 42 (collectively hereinafter “accessors” 45) to central processor 40 charged with management of the present invention. Processor 40 is adapted for simultaneous access both by users 42 setting up jobs or running reports and by operators 41 uploading from scanners 10. Network 7 preferably comprises what is generally known as the “world wide web” or the “Internet,” but one having ordinary skill in the art will recognize that network 7 could be an intranet, wide area network (WAN) or local area network (LAN), without departing from the spirit and scope of the present invention. Typically, accessors 45 and processor 40 interface with network 7 by known means appropriate for the type of network 7. For example, where network 7 is the Internet, access occurs either directly by modem interconnection through an Internet Service Provider (“ISP”) (not shown) or through a proprietary LAN or the like (not shown)

Accessors 45 may or may not be accessing processor 40 from a remote location using the Internet 7, but may be on site with server 7 and accessing it through a limited access LAN proprietary to the operator of processor 40. For example, operators 41 uploading from scanners 10 are accessors 45 who may utilize a common carrier WAN such as a wireless telephone network coupled to processor 40 through the Internet, or operators 41 might be directly linked to processor 40 through a LAN to which a private mobile telephone, two-way radio network or hard-wired telephone lines tie to scanners 10. Likewise, accessors 45 using processor 40 for its reporting functions may be located on site with processor 40 and accessing it through a proprietary LAN, or they may be located elsewhere, such as in a contractor's trailer at job site 4 and accessing processor 40 through the Internet. Preferably, however, processor 40 is operated by an independent service company from which contractors obtain scanners 10 and reports 48. In such case, operators 41 with scanners 10 access processor 40 over a wireless system 6 while other users 42, such as job site 4 managers, access processor 40 through the Internet. One having ordinary skill in the art will recognize that all such variations are within the spirit and scope of the present invention.

Upon contact with processor 40, each accessor 45 first encounters web page 43 adapted to greet and to determine accessor 45's authority for activity on processor 40. Users 42 typically enter job and truck data and/or request job progress reports using registration procedures 47 and report generating procedures 48, while operators 41 more typically upload cumulated truck 1 and load 2 data from scanners 10 and download job and truck 1 data for use in scanning. Both types of access procedures are discussed in detail below.

Processor 40 may include authentication procedures 44 for regulating the activities of accessors 45. A routine (not shown) for registering and obtaining access authorization may be established for accessors 45 first entering processor 40 before they are given selection option 46b. Such routine may be one of several known routines commonly available, and may include different levels of authority to carry out different steps in the invention. For example, supervisors and job managers 42 likely will have a higher level of authority, giving them the ability to edit data they previously registered. Operators 41 handling scanners 10 likely would have only uploading and downloading capabilities and their authentication 44 and selection 46b steps would be handled automatically by the software resident on scanners 10.

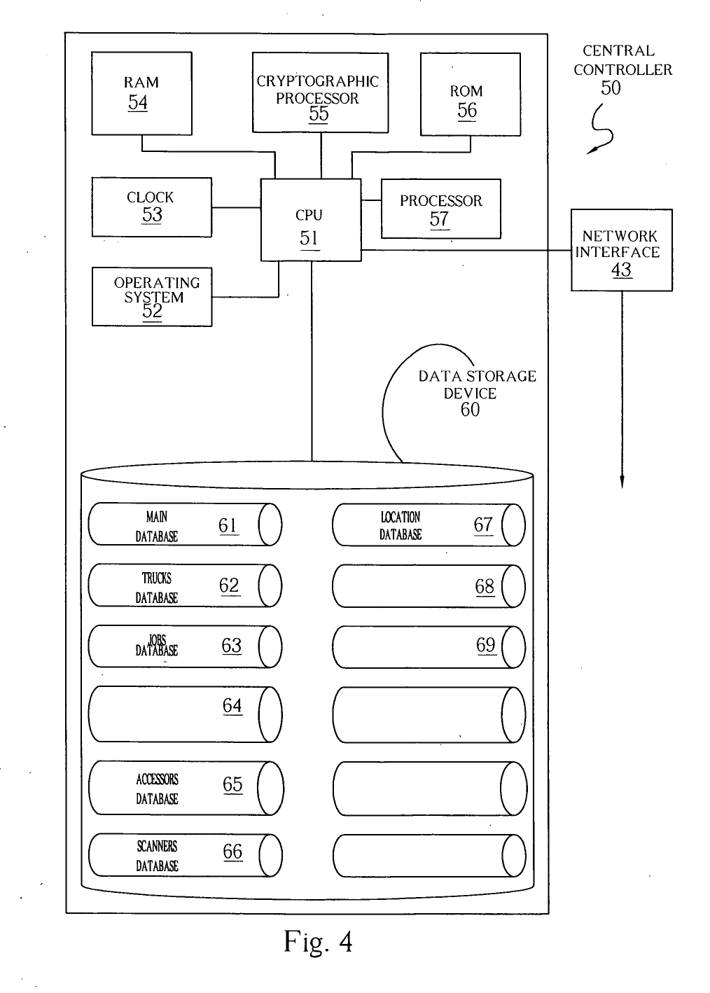

Referring now to FIG. 4, central controller 50 comprises the computer hardware required to implement processor 40. Controller 50 couples to network 7 through network interface 43 and comprises what is generally understood to be a server computer having central processing unit (CPU) 51 programmable to carry out the present invention, operating system 52 for management of CPU 51, clock 53, random access memory (RAM) 54 for temporary storage, read-only memory (ROM) 56 and one or more data storage devices 60 for permanent data storage. Central controller 50 must be capable of processing a high number of transactions and performing a substantial number of mathematical calculations while performing the requirements of the invention. A suitable CPU 51 is an Intel Pentium II microprocessor having a clock speed of at least 300 megahertz (Mhz). Operating system 52 must be suitable for operation with CPU 51. A suitable operating system 52 for the Intel CPU 51 specified above is Unix/FreeBSD version 2.2.8, currently available free from the FreeBSD, Inc. of Gresham, Oreg. (www.freebsd.org). Minimum RAM for supporting operating system 52 using CPU 51 is 128 megabytes. Network interface 43 preferably is a 10 megabit per second base, twisted pair network adapter, or better, allowing communication with a broadband ISP; a suitable network interface is model 3C509-T available from 3Com Company of Santa Clara, Calif. Data storage device 60 is one of a variety of data storage devices widely available, and may include permanent media such as CDROM drives for certain database functions, hard disk magnetic or optical storage units or flash memory.

Resident on data storage device 60 are several primary databases used in processing the transactions of the present invention. The most significant of these appear in FIG. 4 and include main database 61, truck database 62, job database 63, accessors database 65, scanners database 66 and locations database 67. Main database 61 comprises records from each job constructed from information submitted by operators 41 upon scanning trucks 1, including each date and time trucks 1 were scanned, identifier 33 for each truck 1 and its capacity 31, and the job and location related to the scanned truck 1.

Trucks database 62 includes for each registered truck 1 the known truck 1 data previously entered for it, including its identifier 33, driver's name 34, owner's name 36, truck 1's hauling capacity 31 and other information, an indication of truck 1's status (active or inactive) and any other truck 1 information useful to using the present invention with a particular job. Jobs database 63 includes data about jobs with which the present invention has been, is or will be used. Jobs database 63 records include information on the customer, job sites 4, projected fill and/or excavation requirements, start and finish dates and the like.

Accessors database 65 provides passwords, names and status for authorized accessors 45. Scanners database 66 provides relevant information about each scanner 10 used with the present invention, including its serial number, last synchronization time, software version and security information. Locations database 67 stores information about pits 3 and other material sources, as well as dump sites (not shown) or other locales where material loads 2 may be obtained or disposed of. Locations database 67 may also refer to material types, including capacity factors for various types of fill materials and debris. Such capacity factors are used to convert the volume of loose material in loads 2 in trucks 1 to the expected corresponding compacted volume when utilized at job site 4. Additionally, various routines within the software of processor 40 provide means and user interfaces for data entry 47, searching 46a and report generation 48

In use, the present invention requires central processor 40 to be set up for each job by creating job records containing job site 4 location, start and stop dates, engineering requirement for hauling, number of printed tickets 25 needed, automatic synchronizing criteria and any pertinent remote location information. For example, where the present invention monitors a roadway leveling project, excess material excavated from one site 3 may be hauled to where it is needed at more than one remote sites 4 (in this case, sites 3, 4 would be located within the same project area). In such case, the job record prepared for processor 40 would require two locations 4 distinct from each other and source site 3.

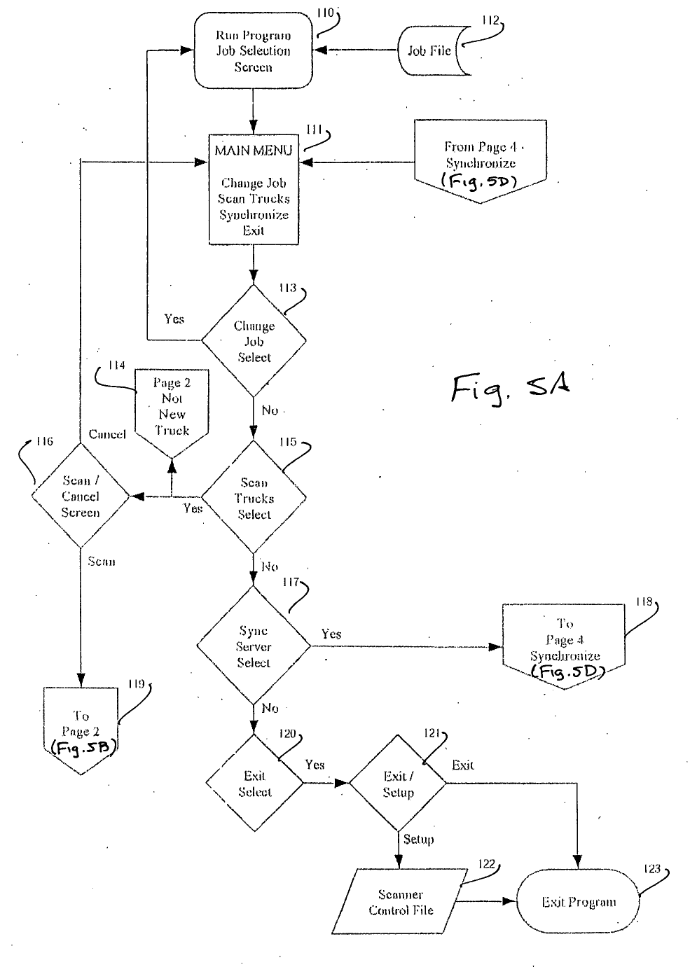

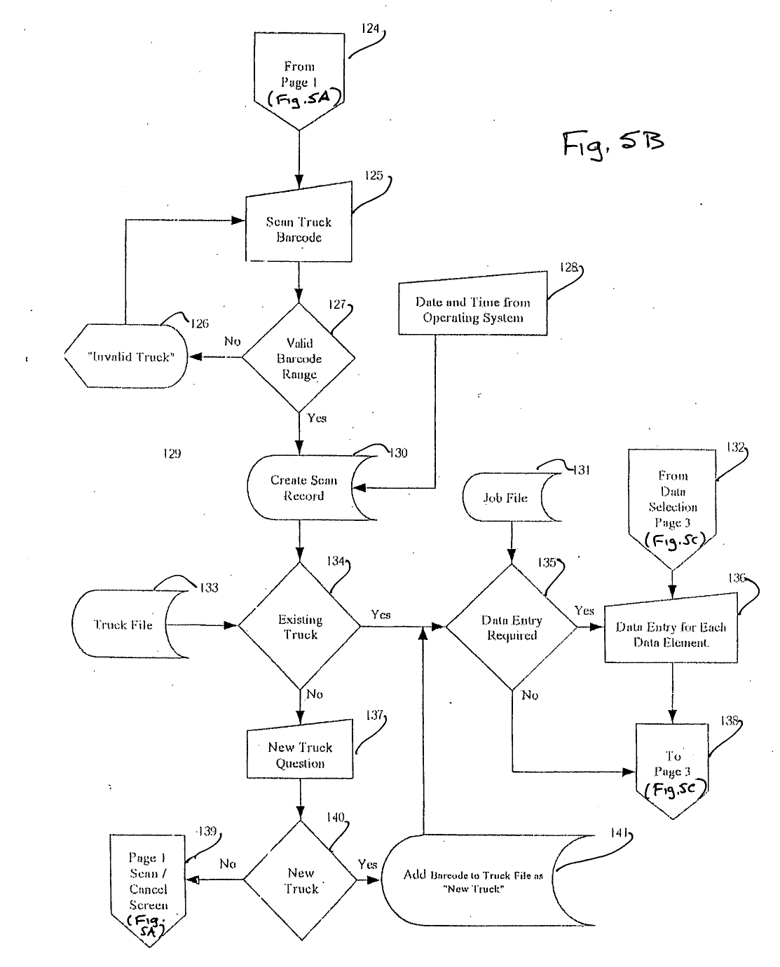

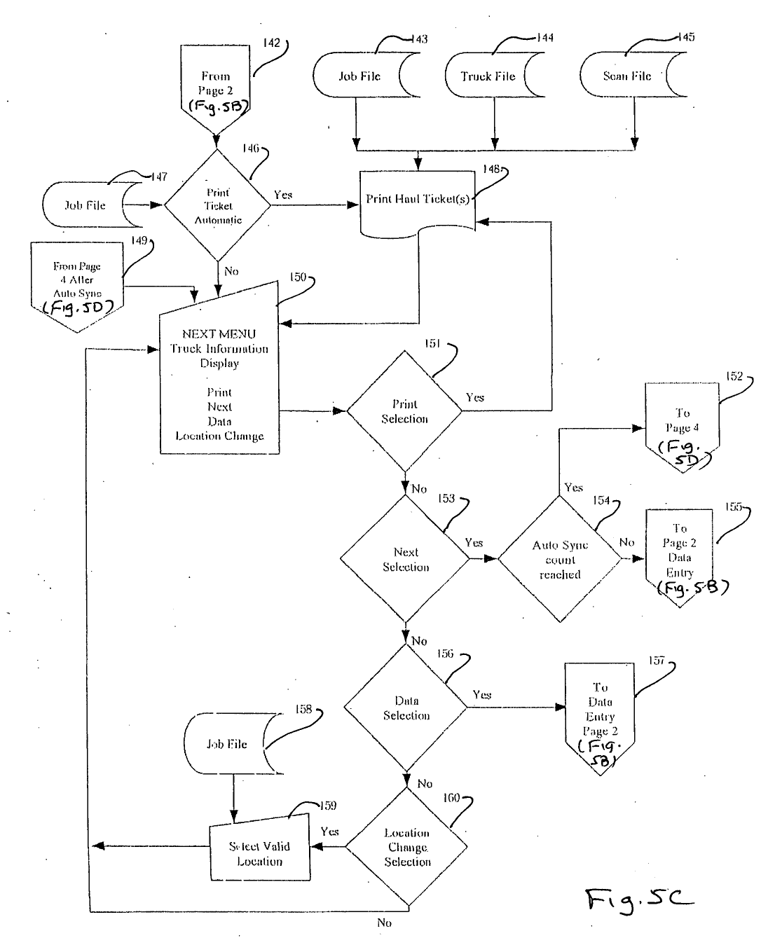

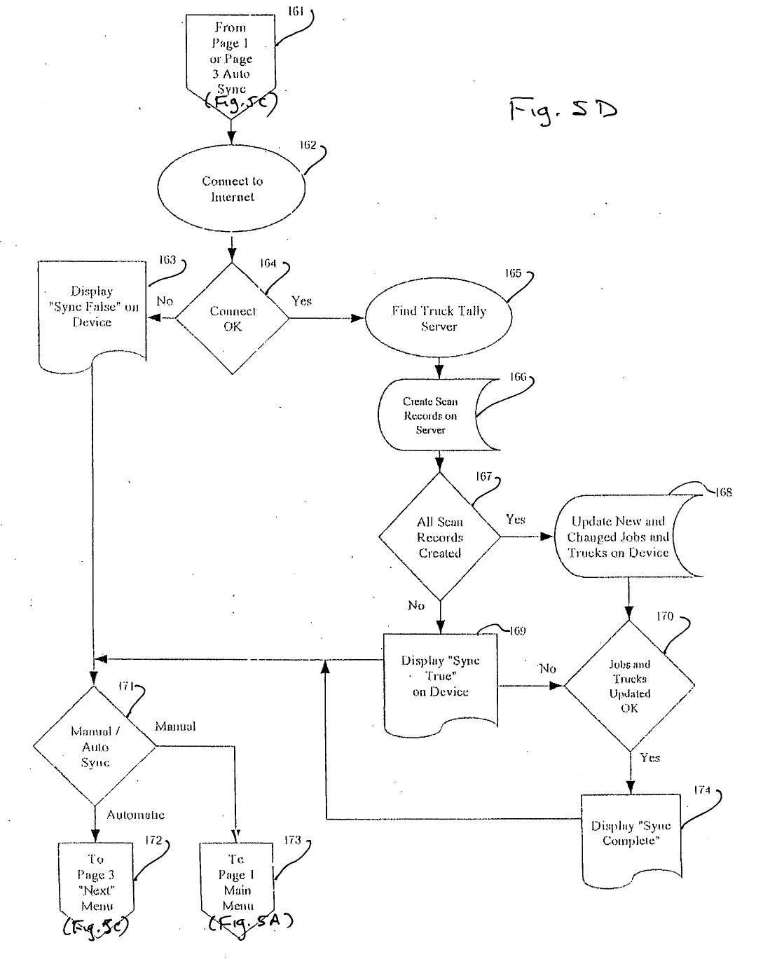

Once the job has been set up on processor 40, job data is downloaded to one or more scanners 10 which are then issued to operator(s) 41 for scanning at job site 4. As discussed in more detail in conjunction with FIGS. 5A-5D below, operator 41 employs scanner 10 first to scan bar code 5 on each truck 1 and to verify on screen 12 that the scan was successful. If additional data, such as the actual weight of load 2, is available on haul ticket 25 or another source (not shown), and the job has been set up to collect it, operator 41 keys in such data in response to a prompt on scanner 10 using touch screen 12. Scanner 10's internal software then creates a scan record of the results and stores the record in temporary storage memory with other such records.

If ticket 25 is to be printed (e.g. as a receipt for an arriving load 2 or as a haul ticket 25 for a departing load 2), operator 41 next aligns and synchronizes scanner 10's transmitter 16 with printer 20's receiver 21 and issues a print command from scanner 10. If more than one ticket 25 is needed, subsequent print commands produce duplicates until all needed tickets 25 are printed. After each ticket 25 prints, the operator gives it to the driver as a receipt or files if for his own future use. After printing, or if no ticket 25 is needed, operator 41 signals to the driver to proceed and then repeats the process for each arriving truck 1. When no trucks 1 are waiting in line for scanning, operator 41 may return scanner 10 to its recharging cradle (not shown) to conserve battery life and/or uploads accumulated truck 1 and load 2 data to processor 40.

The foregoing assumes truck 1 already is registered within trucks 1 database 62 on controller 50. If not, but bar code 5 appears on truck 1, operator 41 receive a “New Truck” display on screen 13 when he attempts to scan bar code 5. This could happen, for example, if bar code 5 had been attached to truck 1 by another company using the present invention, such as pit 3 operators also using scanners 10 to monitor their sites, such as pit 3. If no bar code 5 is attached to truck 1, operator 41, having a supply of new bar codes 5 handy for just such purposes, installs one on truck 1, preferably on the lower part of the truck door at approximately chest high to the operator (FIG. 2). Then, upon operator 41 scanning newly installed bar code 5, screen 13 displays the New Truck message. In either case, operator 41 gathers truck 1 data for eventual encoding into the system on processor 40. This could be accomplished at least two ways.

Manually, operator 41 interrogates the driver and inspects truck 1 for such information as truck description and capacity 31 (FIG. 5A), its license plate number 35, and ownership 36 and driver 34 information. Scanner 10 automatically will have assigned a new truck 1 identifier 5 by which truck 1 will be recognized and tracked within the system on processor 40. Operator 41 associates the truck 1 data he gathers with this new identifier 5 and sets aside the information for future entry onto processor 40. Alternately, prior to bar code 5 being affixed to truck 1, operator 41 or another processor user 42 immediately enters such data into processor 40. The next time scanner 10 uploads accumulated truck 1 and load 2 data, the new truck 1 identifier 5 information already will be on processor 40 and the new truck 1 data immediately integrates with existing data so that new truck 1 may be monitored immediately. Once the new truck 1 data has been gathered, operator 41 signals to the driver to proceed and resumes scanning other trucks 1.

Turning now also to FIGS. 5A-5D, scanner 10 includes software for performing four distinct functions: scanning 125 bar codes 5 (FIG. 5B), entering 137 new truck 1 and bar code 5 information (FIG. 5B), printing 146 haul tickets 25 (FIG. 5C) and synchronizing 162 with processor 40 to upload and download data (FIG. 5D). Additionally, scanner 10 software includes overhead routines for selecting between these functions (FIG. 5A). Upon turning scanner 10 on and preparing for scanning at job site 4, operator 41 first selects 110 an active job from job file 112 already set up and downloaded from processor 40, assuming scanner 10 has been set up to be used on more than one job at a time. If not, scanner 10 skips the job selection screen 110 and goes directly to main menu 111 where four options are displayed: scan 116 trucks 1, synchronize 117 (with processor 40), exit 120, and change jobs 113 to correct an erroneous job selection from the previous menu.

If he is ready to begin scanning trucks 1, operator 41 selects this function 115 and begins testing procedures 124. Initially, to see that the system is working properly, operator 41 should run a test truck with a pre-set identifier that the software on processor 40 knows is merely a test. Operator 41 scans the test bar code 5, checks for a successful scan, and pages through the options for printing 146 and synchronizing 162 to be sure all is in working order. If not, operator 41 examines the equipment to troubleshoot the problem, and may confer with others to solve the problem.

Scanning 150 trucks 1 occupies most of operator 41's time. When operator 41 enters this selection, scanner 10 promptly enables its scanning port 15 for scanning bar codes 5 and displays to operator 41 an instruction to “Scan with Yellow Buttons” message. This indicates that operator 41 should point port 15 toward bar code 5 and hold down the yellow button 14 on scanner 10 to effectuate a scan. An audible beep occurs when scanner 10 reads bar code 5 and a screen message appears 127 indicating either a successful scan 129 or an “Invalid truck” or “New truck” message 126. A successful scan 129 automatically causes scanner 10 to proceed to creating a scan record 130, whereas either other message 129 requires a rescan 125 or entry in to a New Truck registration routine 137. In the latter case, operator 41 attaches 141 a new bar code 5 to new truck 1 and gathers truck data 135. Operator 41 then scans 125 new bar code 5 and processes new truck 1 as normal, and, optionally, enters 136 haul ticket 25 or other data with touch screen 12. Scanner 10 then integrates both sources (bar code 5 and touch screen 12) into a single scan record and stores it for later uploading to processor 50.

Printing 148 signals attempt to synchronize scanner 10 and printer 20, but will attempt to synchronize five (5) times before a failed to print message is displayed on screen 12. Printing tickets 25 is optional, may be automatic 146 (FIG. 5C) or manual 151, and may produce multiple tickets for the same scan. In each case, once scanner 10 and printer 20 synchronize, printer 20 begins printing the predetermined number of tickets 25 required. Scanner 10 draws upon data files 143, 144, 145 to associate truck 1 with job site 4 and send the needed information to printer 20 so that ticket 25 identifies truck 1, job site 4, the date and time, and other pertinent information for later reference. If operator 41 needs additional tickets 25, he repeats the print step 148 until he has the number needed, then returns to the scan 115 truck 1 routine for the next truck.

Synchronizing 118 occurs either on command by operator 41 or automatically after a preset number of scans, in either case when he is not scanning trucks 1. Typically, time required for synchronizing 118 depends upon how much data must be uploaded. Synchronizing can be done several times per day so that the time to do so is kept as short as reasonably possible and to minimize the risk of signal strength disruptions in wireless system 6. Operator 41 evokes synchronizing 118 from the main menu 111 at a convenient time between truck 1 scans. Through wireless system 6, scanner 10 accesses an Internet connection 162 (FIG. 7D) and selects the Create Scan Records option 166 on processor 40. Once all scan records have been created 167, and any new or changed truck 1 or job data has been downloaded 170 from processor 40, a “Sync Complete” message displays on screen 12, indicating the synchronizing step 118 has been completed. Scanner 10 then returns to its Main Menu 111 for further activities. Failure to achieve full synchronization yields a “Sync True” or “Sync False” response, in which case the process must be repeated.

Users needing reports from processor 40 access it similarly. From the browsing menu 46a, pre-programmed reports may be evoked to display pertinent information about particular jobs, trucks 1 or other matters. For managing job sites 4, the present invention renders manual haul ticket 25 handling virtually obsolete, replacing it with contemporaneous, regularly updated information about job site 4 and contrasting progress with engineering requirements. The present invention also minimizes risk of fraud and lost haul tickets 25 while dramatically reducing the work load for invoicing and project management. The present invention carries with it its own additional requirements of data entry and equipment and data base management, but the benefits of instantaneous recall of data, as well as relief from the manual system far outweighs these additional effort requirements.

While the invention has been particularly shown and described with reference to one or more embodiments, it will be understood by those skilled in the art that various changes in form and detail may be made therein without departing from the spirit and scope of the invention. For example, scanning of trucks 1 has been discussed in the context of bar codes 5 pasted directly onto trucks 1, and scanners 10 adapted to read such bar codes, other types of truck 1 identifier methods can be employed, including increasingly available electronic-scan Radio Frequency Identification (RFID) tags (not shown) which not only carry a simple code associated in scanner 10's software with a database of trucks 1, but also may carry additional, variable information useful to contractors. Such information might include the location and time truck 1 picked up its load 2, such information having been written to the RFID tag on truck 1 with a pit 3 scanner. Further, RFID tags offer considerably greater convenience because they can be read from much greater distances than bar codes 25, enabling operator 41 to avoid being stationed close to trucks 1. This in turn allows scanning of trucks from other equipment, such as front-end loaders (not shown) loading trucks 1, rather than requiring an operator 41 dedicated to manning scanner 10.

I claim:

1. A dump truck load monitoring and site management system for tracking dump trucks moving materials at construction sites, the system comprising
truck identifier means disposed on each one of a plurality of dump trucks so that the plurality of trucks may be individually monitored;
scanner means for scanning the truck identifier means to create scan records for each dump truck load;
job identification means for associating the scan records with a particular job at the construction site;
storage means for electronically storing the scan records;
operator interface means adapted to display a plurality of screens to an operator of the scanner means for allowing the operator to receive information about the scan records and to issue commands with the scanner means;
uploading means for uploading the stored modified scan records;
central processor means for receiving and processing the uploaded scan records; and
report and invoice means for generating construction site management reports and invoices from the processed scan records.

2. The load monitoring and site management system according to claim 1 and further comprising
touch screen means coupled to the scanner means for entry of additional load and truck data.

3. The load monitoring and site management system according to claim 1 and further comprising
printing means adapted to couple to the scanner means for printing haul tickets in response to commands from the scanner.

4. The load monitoring and site management system according to claim 3 wherein the printing means comprises
a wireless transmitter port disposed on the scanner means; and
a portable ticket printer having a wireless receiver port adapted to align with the transmitter port to receive print commands from the scanner means.

5. The load monitoring and site management system according to claim 1 wherein the truck identifier means comprises
a printed bar code readable by the scanner means.

6. The load monitoring and site management system according to claim 1 wherein the truck identifier means comprises
a radio frequency identification tag.

7. The load monitoring and site management system according to claim 1 wherein the scanner means comprises
a portable, self-contained bar code scanner.

8. The load monitoring and site management system according to claim 1 wherein the job identification means comprises
data downloaded to the scanner means from the central processor for association with each scan record.

9. The load monitoring and site management system according to claim 1 wherein the operator interface means comprises
a screen disposed on a case containing the scanner means; and
a plurality of buttons on the case for selectively executing a plurality of functions with the scanner means.

10. The load monitoring and site management system according to claim 1 wherein the uploading means comprises
a wireless transmitter adapted to couple to the central processor through an electronic communications network.

11. The load monitoring and site management system according to claim 1 wherein the central processor means comprises
network interface means for coupling to the uploading means;
user interface means for allowing a user to establish and modify a plurality of databases containing
truck capacity and identification data;
scan records; and
job volume and location data;
a computer controller adapted to
receive the uploaded scan records and load data from the scanner means;
associate the scan records and load data with truck and job data to create records in a main databases for each scan record;
analyze the databases to
accumulate load data for all scan records; and
generate construction site management reports.

12. A dump truck load monitoring and site management system for tracking dump trucks moving materials at construction sites, the system comprising
a bar code disposed on each one of a plurality of dump trucks;
an infrared scanner adapted to scan the bar codes and store a scan record for each delivery of a load by a dump truck;
random access memory within the scanner for storing the scan records;
software within the scanner adapted to store the scan records and to upload them for analysis and reporting;
an operator interface disposed on the scanner and adapted to display a plurality of screens to an operator of the scanner means in response to instructions from the software;
an uploading routine within the software for uploading the stored scan records;
a central processor adapted to receive the uploaded scan records and associating them with additional data for processing construction site fill progress; and
report routines executable by the central processor and adapted to generate construction site management reports from the processed scan records.

13. The load monitoring and site management system according to claim 12 wherein the operator interface further comprises
a touch screen generated by the software for entry of additional load and truck data.

14. The load monitoring and site management system according to claim 12 and further comprising
a printer adapted to couple to the scanner to receive commands from the scanner for printing tickets.

15. The load monitoring and site management system according to claim 14 and further comprising
an infrared wireless transmitter disposed on one end of the scanner for transmitting print commands; and
an infrared wireless receiver disposed on the printer and adapted to align with the transmitter port to receive print commands from the scanner.

16. A method of monitoring dump truck load deliveries at construction sites, the construction sites having a plurality of dump trucks moving excavated materials from one location to another, the method comprising
providing a central processor having preprogrammed construction site data and dump truck owner and capacity data;
providing a scanner for reading a bar code disposed on each dump truck; then
scanning each bar code as the dump truck arrives at the construction site to create a scan record; then
associating each scan record with a job site identifier and the date and time the dump truck arrived;
accumulating a plurality of bar code scan records in storage; then
uploading the accumulated bar code scan records to a central processor through a wireless network; then
analyzing the uploaded scan records in light of the preprogrammed construction data and capacity data; and
generating a plurality of pre-selected reports from the analyzed data to contrast the accumulated scan records with construction site requirements.

17. The method according to claim 16 and further comprising the steps of
providing touch screen means for entering additional load and truck data into the scanner means;
keying in said additional load and truck data; and
integrating said additional load and truck data with the bar code scan into the scan record.

18. The method according to claim 16 and further comprising the steps of
analyzing the uploaded scan records in light of the preprogrammed dump truck owner and capacity data; and
generating a plurality of financial reports adapted for use as settlement of payments to the dump truck owners for delivering the excavated materials.
